(19) United States
(12) Patent Application Publication
(10) Pub. No.: US 2025/0010177 A1
(43) Pub. Date: Jan. 9, 2025

(54) RECORDING MEDIUM AND INFORMATION PROCESSING DEVICE

(71) Applicant: SEGA CORPORATION, Tokyo (JP)

(72) Inventors: Kazuki Yoshikawa, Tokyo (JP); Yu Suganuma, Tokyo (JP); Toshiyuki Mukaiyama, Tokyo (JP)

(73) Assignee: SEGA CORPORATION, Tokyo (JP)

(21) Appl. No.: 18/894,935

(22) Filed: Sep. 24, 2024

Related U.S. Application Data
(63) Continuation of application No. PCT/JP2023/006329, filed on Feb. 21, 2023.

(30) Foreign Application Priority Data
Mar. 31, 2022 (JP) 2022-060584

(51) Int. Cl. A63F 13/216; A63F 13/69

(52) U.S. Cl. CPC A63F 13/216; A63F 13/69

(57) ABSTRACT

A non-transitory computer readable recording medium stores instructions that cause a computer to execute: acquiring first location information of a player in a real world; moving an object in a virtual world to a location corresponding to the first location information; storing, in a memory, second location information of the player or of the object in response to an operation; switching the location from the location corresponding to the first location information to a location based on the second location information; after the switching, receiving an operation to select a game event from among game events occurring around the location of the first object that has been switched, and conducting the game event selected by the operation; and upon detecting that a specific condition has been satisfied, releasing the location switched and returning it to the location corresponding to the first location information.

### BACKGROUND

### Technical Field

The present invention relates to a recording medium storing instructions and an information processing device.

### Description of Related Art

In location-based games, location information of a player in the real world is reflected in the game content.

For example, Patent Literature 1 discloses a technique in which a character is moved in a virtual world based on the location information of the player in the real world, allowing the player to participate in game events in various locations.

### PATENT LITERATURE

Patent Literature 1: Japanese Patent No. 3,551,856

### Technological Problem to be Solved by the Invention

However, with gaming technology described in Patent Literature 1, a player had to stay in a location near a game event in order to participate in that game event, and there was the risk that the player would have to move due to time constraints or player crowding, and would be unable to participate in the game event or other game events nearby.

### SUMMARY

One or more embodiments of the present invention provide a technological improvement over such conventional gaming technologies discussed above. In particular, one or more embodiments of the present invention provide a non-transitory computer readable recording medium storing instructions and an information processing device that enable proceeding location-based games without requiring a player in a game event to stay at a location near the game event.

According to a first mode of the present invention, the non-transitory computer readable recording medium stores instructions causing a computer to conduct a game event, and to execute: acquiring first location information of a player in a real world; moving a first object in a virtual world to a location corresponding to the first location information; storing, in a memory, second location information of the player or of the first object in response to an operation on a display by the player; in response to an operation on the display by the player, switching a location of the first object from the location corresponding to the first location information to a location based on the second location information; after the switching of the location of the first object, receiving an operation on the display by the player to select a game event from among one or more game events occurring around the location of the first object that has been switched, and conducting the game event selected by the operation; and upon detecting that a specific condition has been satisfied, releasing the location of the first object from the location of the first object that has been switched and returning the location of the first object to the location corresponding to the first location information.

Also, with the non-transitory computer readable recording medium according to a second mode of the present invention, the switching includes: in response to the operation, accepting a designation of one location within a specific range including a location indicated by the second location information, as the location based on the second location information.

Also, with the non-transitory computer readable recording medium according to a third mode of the present invention, the storing includes: in response to the operation, storing the second location information to be associated with a second object different from the first object, and the instructions further cause the computer to execute: displaying, in the virtual world, the second object at a location indicated by the second location information associated with the second object.

Also, with the non-transitory computer readable recording medium according to a fourth mode of the present invention, the switching includes: in response to the operation, switching the location of the first object from the location corresponding to the first location information to the location based on the second location information associated with the second object, and the second object is transferable between a plurality of players.

Also, with the non-transitory computer readable recording medium according to a fifth mode of the present invention, the instructions further cause the computer to execute: granting a reward based on a location of the second object.

Also, with the non-transitory computer readable recording medium according to a sixth mode of the present invention, the storing includes: storing the second location information in response to an operation to use a specific item by the player, and the specific item has an upper limit on a number of use.

Also, with the non-transitory computer readable recording medium according to a seventh mode of the present invention, the instructions further cause the computer to execute: suggesting via the display using the specific item based on an item or character possessed by the player and the location corresponding to the first location information.

Also, with the non-transitory computer readable recording medium according to an eighth mode of the present invention, the releasing includes: changing the specific condition based on a movement amount of the player.

Also, according to a ninth mode of the present invention, an information processing device conducts a game event, and comprises: a memory; display; and a central processing unit (CPU) that: acquires first location information of a player in the real world; moves an object in a virtual world to a location corresponding to the first location information; storing, in the memory, second location information of the player or of the object in response to an operation on a display by the player; in response to an operation on the display by the player, switches a location of the object from the location corresponding to the first location information to a location based on the second location information; after the switching of the location of the object, receives an operation on the display by the player to select a game event from among one or more game events occurring around the location of the object that has been switched, and conducts the game event selected by the operation; and upon detecting that a specific condition has been satisfied, releases the location of the object from the location of the object that has been switched and returning the location of the object to the location corresponding to the first location information.

With the aspects of the present invention, it becomes possible to proceed location-based games without requiring a player in a game event to stay at a location near the game event.

### BRIEF DESCRIPTION OF THE DRAWINGS

FIG. 1 is a block diagram showing an example of the overall configuration of a game system according to one or more embodiments of the present invention;

FIG. 2 is a diagram schematically showing an example of the hardware configuration of the server device shown in FIG. 1;

FIG. 3 is a diagram showing an example of the hardware configuration of a smartphone as the terminal device shown in FIG. 1;

FIG. 4A is a diagram illustrating an overview of the game according to one or more embodiments, and shows the real world W1;

FIG. 4B is a diagram illustrating an overview of the game according to one or more embodiments, and shows a virtual world W2;

FIG. 5 is a block diagram showing an example of the functional configuration of a terminal device;

FIG. 6 is a flowchart showing an example of the flow of processing executed by the terminal device in the game system 1 according to one or more embodiments;

FIG. 7A is a diagram showing an example of a game screen of the game according to one or more embodiments;

FIG. 7B is a diagram showing a game screen continuing from the game screen shown in FIG. 7A;

FIG. 7C is a diagram showing a game screen continuing from the game screen shown in FIG. 7B;

FIG. 7D is a diagram showing an example of a designation screen for accepting a location designation from player P;

FIG. 7E is a diagram showing a game screen continuing from the game screen shown in FIG. 7C; and

FIG. 8 is a diagram showing an example of a pin menu screen 80.

### DETAILED DESCRIPTION

Embodiments of the present invention will now be described with reference to the appended drawings. To facilitate understanding of the description, components and steps that are the same will be numbered the same as much as possible in the drawings, and redundant description will be omitted.

### Overall Configuration

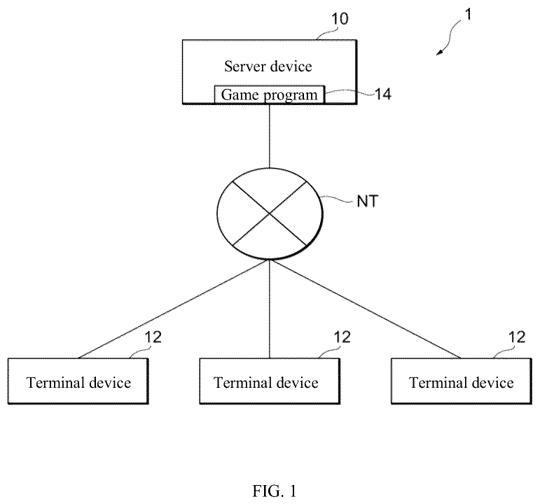

FIG. 1 is a block diagram showing an example of the overall configuration of a game system 1 according to one or more embodiments.

As shown in FIG. 1, a game system 1 comprises a server device 10 and one or more terminal devices 12. The server device 10 and terminal devices 12 are connected so as to be able to communicate via a communication network NT such as an intranet, a telephone line, or the Internet.

The server device 10 is an information processing device that provides the execution results of the game obtained by executing instructions such as a game program 14, or the instructions themselves, to the player of each terminal device 12 via the communication network NT.

Each terminal device 12 is a portable communication terminal device that can be operated and carried around by a player. Examples of the terminal device 12 include a smartphone, a mobile phone, a tablet, a notebook computer, and so forth. Each terminal device 12 is an information processing device that provides a game to a player by transmitting player operation information to the server device 10 and outputting the execution result of the instructions received from the server device 10, or by executing the instructions based on player operation information. The terminal device 12 and the server device 10 may jointly execute the instructions.

### Hardware Configuration

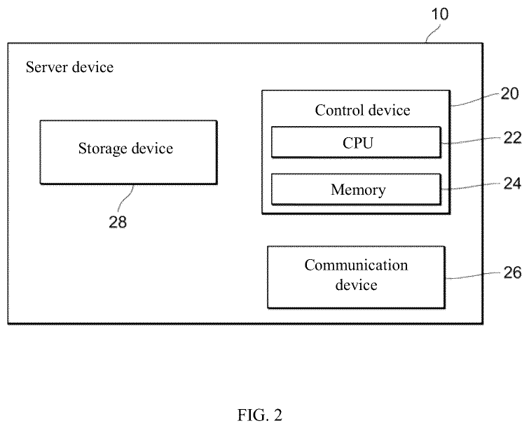

FIG. 2 is a diagram schematically showing an example of the hardware configuration of the server device 10 shown in FIG. 1.

As shown in FIG. 2, the server device 10 comprises a control device 20, a communication device 26, and a storage device 28.

The control device 20 mainly comprises a CPU (central processing unit) 22 and a memory 24.

In the control device 20, the CPU 22 functions as various functional units by executing specific instructions stored in the memory 24, the storage device 28, or the like. These functional units will be described in detail below.

The communication device 26 is constituted by a communication interface or the like for communicating with an external device. The communication device 26 sends and receives various kinds of information to and from the terminal device 12, for example.

The storage device 28 is constituted by a hard disk or the like. The storage device 28 stores various kinds of instructions and various kinds of information necessary for executing processing in the control device 20, including the game program 14, as well as information about processing results.

The server device 10 can be realized by using an information processing device such as a dedicated or general-purpose server computer. Also, the server device 10 may be constituted by a single information processing device, or may be constituted by a plurality of information processing devices distributed on the communication network NT. Also, FIG. 2 shows only a part of the main hardware configuration of the server device 10, and the server device 10 can comprise other components that are ordinarily provided to a server.

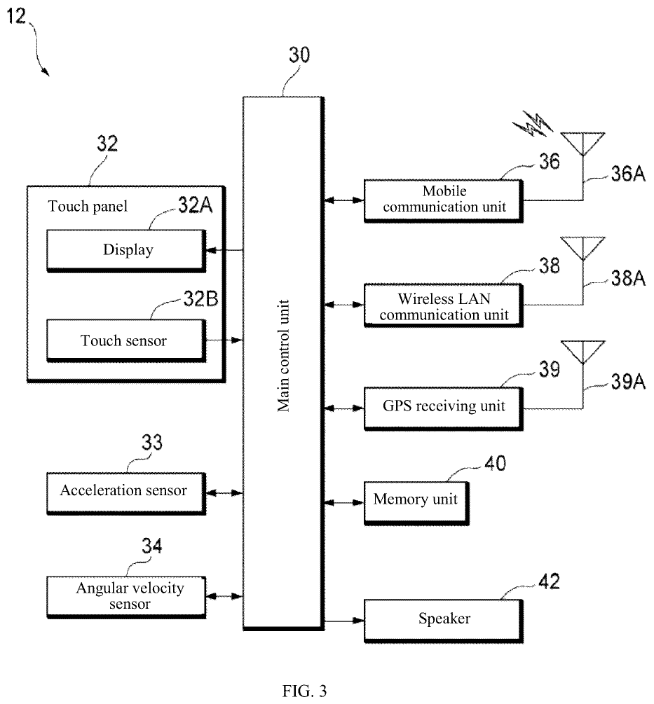

FIG. 3 is a diagram showing an example of the hardware configuration of a smartphone serving as the terminal device 12 shown in FIG. 1.

As shown in FIG. 3, the terminal device 12 comprises a main control unit (or main controller) 30, a touch panel 32, an acceleration sensor 33, an angular velocity sensor 34, a mobile communication unit (or mobile communication interface) 36, a wireless LAN communication unit (or wireless LAN communication interface) 38, a GPS receiving unit (or GPS receiver) 39, a memory unit (or memory) 40, and a speaker 42.

The main control unit 30 includes a CPU, a memory, and so forth. This main control unit 30 is connected to the touch panel 32 (serving as a display input device), the acceleration sensor 33, the angular velocity sensor 34, the mobile communication unit 36, the wireless LAN communication unit 38, the GPS receiving unit 39, the memory unit 40, and the speaker 42. The main control unit 30 has the function of controlling these connected devices.

The touch panel 32 has both a display function and an input function, and is made up of a display 32A that handles the display function, and a touch sensor 32B that handles the input function. In one or more embodiments, the display 32A can display game images, including operation input images such as button images, cross key images, and joystick images. The touch sensor 32B is capable of sensing the input position of the player relative to the game image.

The acceleration sensor 33 is capable of measuring the acceleration of the terminal device 12, that is, the acceleration of the player. More specifically, the acceleration sensor 33 can detect the movement and vibration of the player.

The angular velocity sensor 34 is capable of measuring the orientation and inclination of the terminal device 12.

The mobile communication unit 36 has the function of connecting to a mobile communication network via an antenna 36A and communicating with other communication devices connected to the mobile communication network.

The wireless LAN communication unit 38 has the function of connecting to a communication network NT via the antenna 38A and communicating with other devices such as the server device 10 connected to the communication network NT.

The GPS receiving unit 39 has the function of receiving radio waves from GPS satellites via the antenna 39A and acquiring location information indicating the current location of the player. This location information is latitude and longitude, for example.

The memory unit 40 stores various instructions including all or part of the game program 14, and other various kinds of data.

The speaker 42 has the function of outputting game sounds and so forth.

### Game Overview

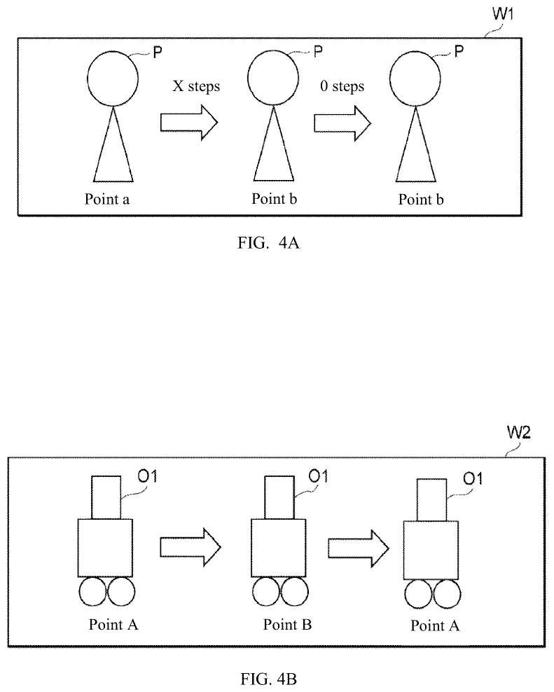

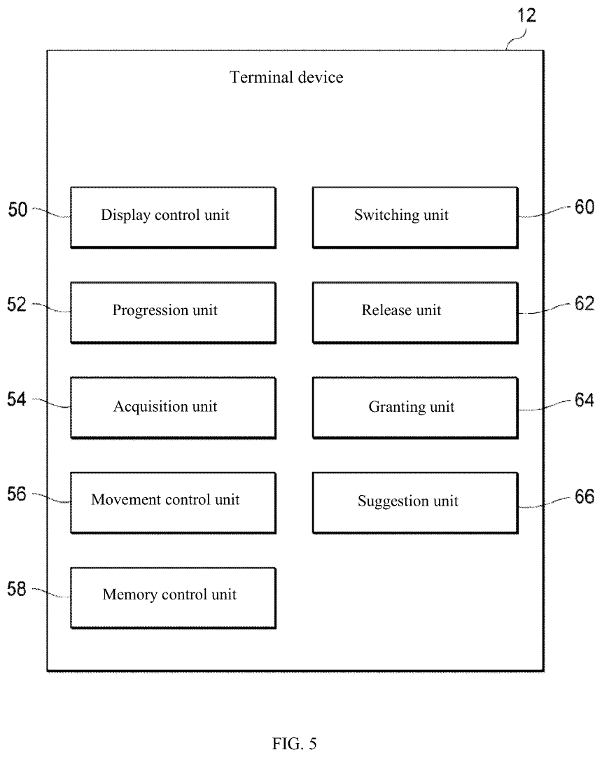

FIG. 4A is a diagram illustrating an overview of the game according to one or more embodiments, and shows the real world W1. FIG. 4B is a diagram illustrating an overview of the game according to one or more embodiments, and shows a virtual world W2.

As shown in FIGS. 4A and 4B, the game according to one or more embodiments is a location-based game in which the location and movement of a player P in the real world W1 are reflected in a virtual world W2. In this game, for example, when the player P moves in the real world W1, a first object O1 disposed in the virtual world W2 also moves. The player P also performs input operations and the like on the touch panel 32 to give instructions for the first object O1. Examples of the first object O1 include a character, a robot, a car, an airplane, a ship, and the like.

Also, in one or more embodiments, a new function is provided to switch the location of the first object O1 from a location corresponding to the location information of the player P to a location based on location information stored through an operation by the player P. More specifically, as shown in FIGS. 4A and 4B, when the player P wants to go back to a point A in the virtual world W2 which corresponds to a point a in the real world W1, the point A is stored in the terminal device 12, etc. Next, as shown in FIG. 4A, the player P moves X steps away from point a to point b. As this happens, as shown in FIG. 4B, the first object O1 moves from point A corresponding to point a, to point B corresponding to point b. Then, the player P performs an operation to switch the location of the first object O1 in the virtual world W2 from a location corresponding to the location information of the player P to a location based on the location information stored through an operation by the player P, that is, to point A, without moving a single step from point b (having taken no steps). This allows the player P to move the location of the first object O1 to point A corresponding to point a without having to go back to point a, and to enjoy various game events occurring around point A.

Also, with the game according to one or more embodiments, there are a number of kinds of quests, each of which has a different title. Quests can be selected by the player P on a quest menu screen or the like. Quests may be associated with enemy characters that appear in the virtual world W2, or with a boss character that appears at the goal point of the quest. For instance, the player P may be able to select a new quest by winning a battle against a boss character. In a new quest, the difficulty level is set higher than in quests that the player P was already able to select, and the enemy characters and boss characters may have stronger abilities.

Also, in the game according to one or more embodiments, the goal point of each quest is set at a landmark in the real world W1 of the player P, that is, a virtual landmark in the virtual world W2. Examples of such a landmark may include commercial facilities, public facilities, or tourist attractions. On the way to the goal point of a quest, the player P may encounter an enemy character according to the quest and the location information. Also, the player P can encounter a boss character corresponding to a quest by moving to the vicinity (a specific range, such as within a radius of 20 m) of the landmark where the goal point of that quest has been set. The goal point of each quest may be set by the player P or by the game manager.

Also, the game according to one or more embodiments allows the use of game currency. This game currency includes paid currency and unpaid currency. Paid currency is paid content that can be acquired by a purchase procedure (payment) using money, a prepaid card, a credit card, electronic money, crypto assets, or the like. Examples of paid currency include charged items (paid items), charged coins (paid coins), and charged points (paid points). For example, with the game according to one or more embodiments, one charged item can be purchased for 100 yen. On the other hand, unpaid currency is unpaid content that can be acquired by playing the game. Examples of unpaid currency include non-charged items (unpaid items), non-charged coins (unpaid coins), and non-charged points (unpaid points). Examples of executing a game may include the player logging into a game, clearing a quest for the first time, and completing a mission. Unpaid currency can be consumed in the same way as paid currency in various kinds of games.

### Functional Components

FIG. 5 is a block diagram showing an example of the functional configuration of the terminal device 12.

As shown in FIG. 5, the terminal device 12 has, as its functional configuration, a display control unit 50, a progression unit 52, an acquisition unit 54, a movement control unit 56, a memory control unit 58, a switching unit 60, a release unit 62, a granting unit 64, and a suggestion unit 66. These functional components are realized when the main control unit 30 executes the instructions. In addition, some or all of these functional components may be provided to the server device 10.

The display control unit 50 controls the display of the virtual world W2 and the first object O1 on the display 32A of the terminal device 12. Also, the display control unit 50 controls the display of a second object that is different from the first object O1 and is linked to the location information of the player P or the location information of the first object O1. Examples of this second object include a pin, a mark, a stone, an arrow, and a character. Also, the second object may be transferable between players P. In other words, the second object can be bought and sold, with or without payment. Also, the second object may be exchangeable between players P.

The progression unit 52 causes the game and game events in the game to be conducted based on the movement of the first object O1 or an operation by the player P.

The acquisition unit 54 controls the GPS receiving unit 39 to acquire location information of the player P in the real world W1.

The movement control unit 56 moves the first object O1 to a location in the virtual world W2 corresponding to the location information acquired by the acquisition unit 54, that is, to a location in the virtual world W2 corresponding to the location information of the player P.

In response to an operation by the player P on the touch panel 32, the memory control unit 58 stores location information of the player P or location information of the first object O1. In one or more embodiments, in response to an operation by the player P of using a specific item on the touch panel 32, the memory control unit 58 links location information of the player P or location information of the first object O1 to a second object that is different from the first object O1, and stores this information in the memory device 28 of the server device 10. The second object linked to this location information is also transferable between players P (can be bought or sold). As transfer processing, for example, the memory control unit 58 releases the linking of the second object to the player P and links the second object to another player. The transfer price of the second object may be determined manually by the player P or automatically by the game. When the price is determined automatically by the game, the transfer price of the second object may be determined based on the difference between the location information stored in the second object and the current location. For example, the transfer price of the second object may be determined to be higher in proportion to the difference between the location information stored in the second object and the current location, or it may be determined to be lower in proportion to the difference between the location information stored in the second object and the current location. Also, in order to maintain a good balance in the game, a fee may be added to the transfer price of the second object on the game side. Here again, the fee may be determined based on the difference between the location information stored in the second object and the current location. For example, the fee may be determined to be higher in proportion to the difference between the location information stored in the second object and the current location, or it may be determined to be lower in proportion to the difference between the location information stored in the second object and the current location.

The above-mentioned specific items include pins, marks, stones, arrows, etc., just as with the second object. A specific item can be acquired by the player P through a purchase procedure. Also, a specific item can be acquired by the player P by consuming paid currency or unpaid currency. Also, an upper limit may be set for the number of use of a specific item. For example, an upper limit may be set for the number of use of a specific item within a specific period of time, such as once a day, once a week, or once during a game event period. Also, an upper limit may be set for the number of use of a specific item for each specific game event, such as twice per quest or once per gacha (loot box). Also, this upper limit may be changed to be higher when the player P consumes paid currency or unpaid currency.

In response to an operation by the player P on the touch panel 32, the switching unit 60 switches the location of the first object O1 from a location corresponding to the location information acquired by the acquisition unit 54 to a location based on the location information stored in the memory control unit 58. For example, in response to an operation by the player P on the touch panel 32, the switching unit 60 switches the location of the first object O1 from a location corresponding to the location information acquired by the acquisition unit 54 to a location based on the location information linked to the second object.

Also, in response to an operation by the player P, the switching unit 60 may accept the designation of one location within a specific range including the location indicated by the location information stored in the memory control unit 58 as a location based on this location information. Examples of locations based on this location information include, besides the one location designated in response to an operation by the player P as described above, a location indicated by this location information, a location a specific distance away from the location indicated by this location information, and a location automatically selected from within a specific range including the location indicated by this location information.

When a specific condition is satisfied, the release unit 62 releases the location of the first object O1 from the location based on the location information stored in the memory control unit 58, and returns it to a location corresponding to the location information acquired by the acquisition unit 54. Examples of this specific condition include a condition that a time limit such as one minute or five minutes has elapsed since the location of the first object O1 was switched to a location based on the location information stored by the memory control unit 58, or a condition based on an operation by the player P. Examples of conditions based on an operation by the player P include a condition that player P has performed an operation a specific number of times, a condition that player P has participated in a game event a specific number of times, a condition that a quest has been cleared, a condition that an item has been acquired, a condition that a specific enemy character has been defeated, and a condition that a specific item has been acquired.

Also, the release unit 62 may change the specific condition based on the amount of movement of the player P, such as the number of steps, the distance, or the time when the player P moves. More specifically, the release unit 62 relaxes the specific condition when the amount of movement of the player P exceeds a threshold value. For example, the above-mentioned time limit may be increased if the number of steps taken by player P exceeds 10,000 steps, the specific number of times may be increased if the travel time of the player P exceeds one hour, or the specific number of times may be increased if the travel distance of the player P exceeds 10 km. Conversely, the release unit 62 may make the specific condition stricter when the amount of movement of the player P is at or below the threshold value. For example, the time limit may be reduced if the number of steps taken by the player P is 10,000 steps or less, the specific number of times may be reduced if the travel time of the player P is one hour or less, or the specific number of times may be reduced if the travel distance of the player P is 10 km or less.

Also, the release unit 62 may change the specific conditions based on the rank or status of the player P. More specifically, the release unit 62 relaxes the specific condition in proportion to how high the rank or status of the player P is. Conversely, the release unit 62 may make the specific condition stricter in proportion to how high the rank or status of the player P is.

The release unit 62 may also change the specific condition based on the weather conditions around the place where the player P is located. More specifically, if the weather conditions around the location of the player P indicate rain, it may be difficult for the player P to move around and enjoy the game, so the release unit 62 may relax the specific condition so that the player P is able to enjoy the game as much as possible. Also, if the weather conditions around the location of the player P indicate heavy snowfall, the player P may be unable to move about and cannot enjoy the game at all, so the release unit 62 may further relax the specific condition so that player P is able to enjoy the game from home. Conversely, if the weather conditions around the location where the player P is located indicate fine weather, the specific condition may be made stricter.

Also, the release unit 62 may relax the specific condition when the player P consumes paid currency or unpaid currency. For example, if the player P consumes 100 paid stones as paid currency, the time limit may be increased by 10 minutes, or if the player P consumes 100 unpaid stones as unpaid currency, the time limit may be increased by 5 minutes.

The granting unit 64 grants a reward based on the location of the second object. More specifically, the granting unit 64 grants a reward when the location (linked location) where the second object was previously placed by the player P substantially coincides with the location (linked location) where the second object is currently placed. In other words, the granting unit 64 grants a reward when the player P goes back to a location where the second object was placed in the past. Also, the granting unit 64 may grant a reward based on the positional relationship between the location of a second object placed by the player P and the location of a second object placed by another player. For example, a reward may be granted when the positional relationship of the second object becomes a predetermined positional relationship.

Examples of rewards include unpaid currency, items, characters, weapons, and armor. In particular, the reward may be related to the location where the second object is placed. More specifically, the reward may be an item or character that can only be obtained at the location where the second object is placed.

The suggestion unit 66 suggests to the player P the use of a specific item based on an item or character possessed by the player P and a location in the virtual world W2 corresponding to the location information acquired by the acquisition unit 54. More specifically, if an item possessed by the player P does not match an item that can be acquired at the location corresponding to the location information acquired by acquisition unit 54 (if the player P does not possess an item that can be acquired at the location corresponding to the location information acquired by acquisition unit 54), then the use of a specific item is suggested to the player P. Also, if a character possessed by player P does not match a character that can be acquired at the location corresponding to the location information acquired by acquisition unit 54 (if the player P does not possess a character that can be acquired at the location corresponding to the location information acquired by acquisition unit 54), then the use of a specific item may be suggested to the player P.

Also, the suggestion unit 66 may suggest to the player P the use of a specific item based on the rank or status of the player P and the level or status of an enemy that appears at a location corresponding to the location information acquired by the acquisition unit 54. For example, the suggestion unit 66 may suggest to the player P the use of a specific item when the rank or status of the player P substantially coincides with the level or status of an enemy that appears at a location corresponding to the location information acquired by the acquisition unit 54. Also, the suggestion unit 66 may suggest to the player P the use of a specific item when the rank or status of the player P is higher than the level or status of an enemy that appears at a location corresponding to the location information acquired by the acquisition unit 54. Conversely, the suggestion unit 66 may suggest to the player P the use of a specific item when the rank or status of the player P is lower than the level or status of an enemy that appears at a location corresponding to the location information acquired by the acquisition unit 54.

### Example of Game Screen

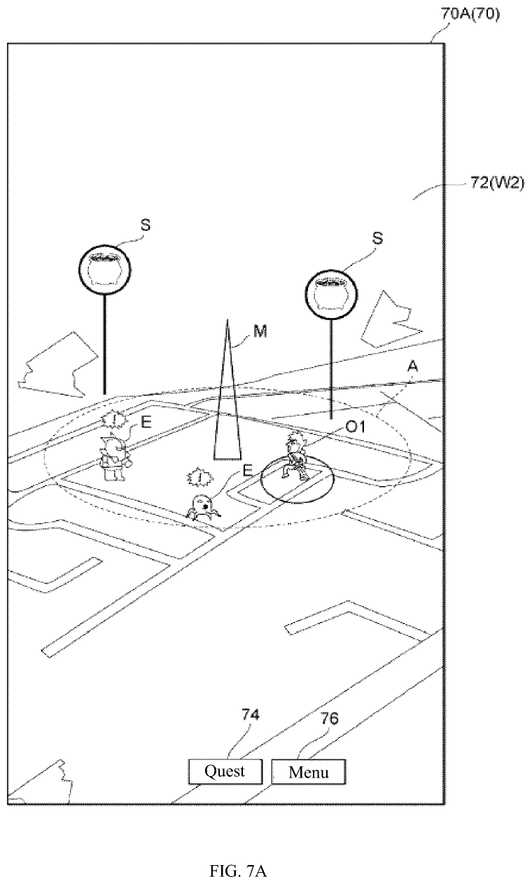

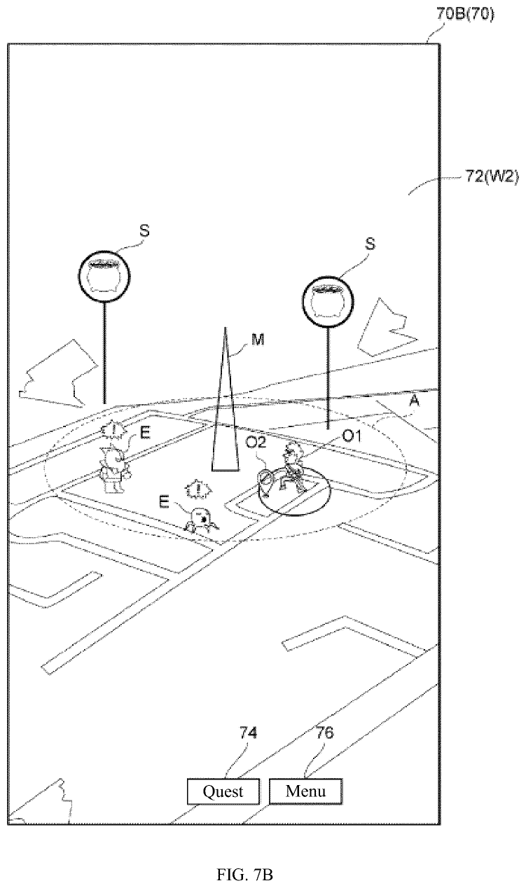

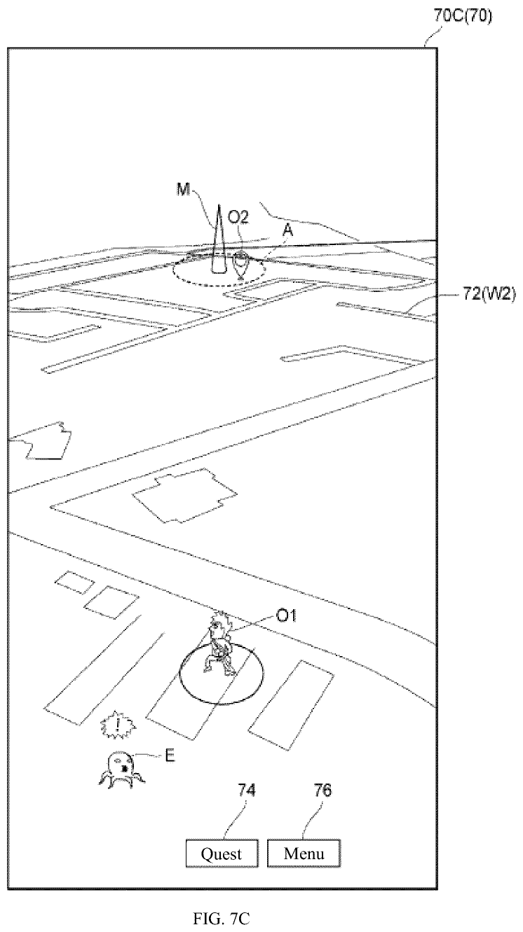

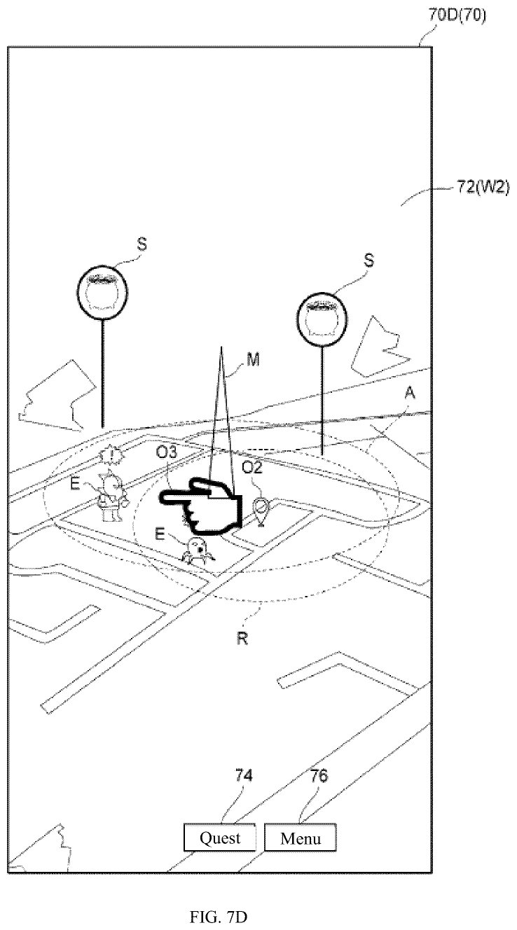

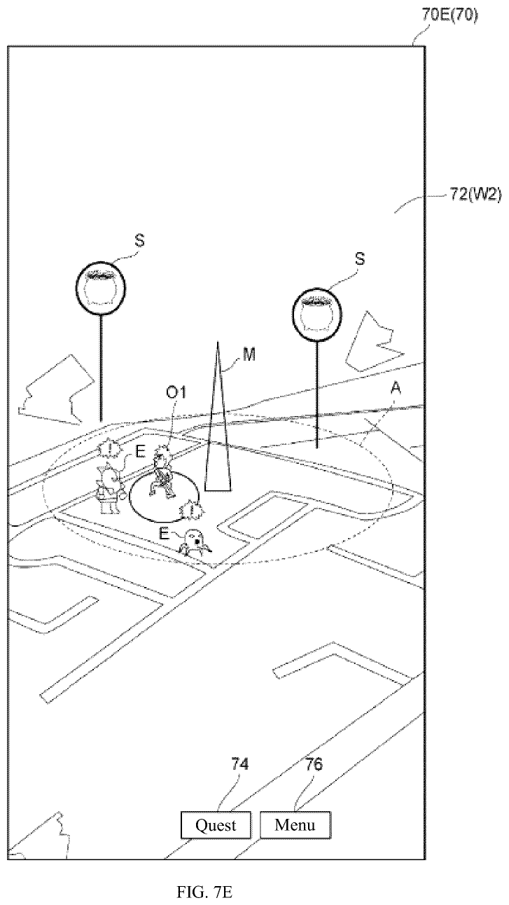

FIG. 7A is a diagram showing an example of a game screen of the game according to one or more embodiments.

As shown in FIG. 7A, a game field 72 (serving as the virtual world W2), a quest button 74, and a menu button 76 are displayed on a game screen 70A.

The game field 72 is made to resemble the scenery around the location where the player P is located in the real world W1, for example. In this game field 72 are displayed a first object O1 (player character), an enemy character E, a virtual landmark M, and a spot S. The first object O1 is displayed based on the player information (possessed character information) of the player P stored in the server device 10. The enemy character E is displayed based on the enemy character information stored in the server device 10. The virtual landmark M indicates a store or facility, an enemy boss character, or the like. A specific range A is set in the game field 72, centered on this virtual landmark M. The specific range A indicates the range over which the player P can participate in a game event occurring at the virtual landmark M. The spot S is a place where the player P can participate in game events where rewards are granted, where the hit points and magic points of the player P are restored, where the status of the player P is raised, or where the player P proceeds through the game while talking with virtual residents. The player P can participate in a game event at this spot S when the first object O1 approaches the spot S and the player P presses on the spot S.

The quest button 74 is used to display quests that the player P can play, out of the plurality of quests indicated by the quest information stored in the server device 10.

The menu button 76 is used to display a menu for setting or ending a game, or a pin menu (discussed below).

### Flow of Processing

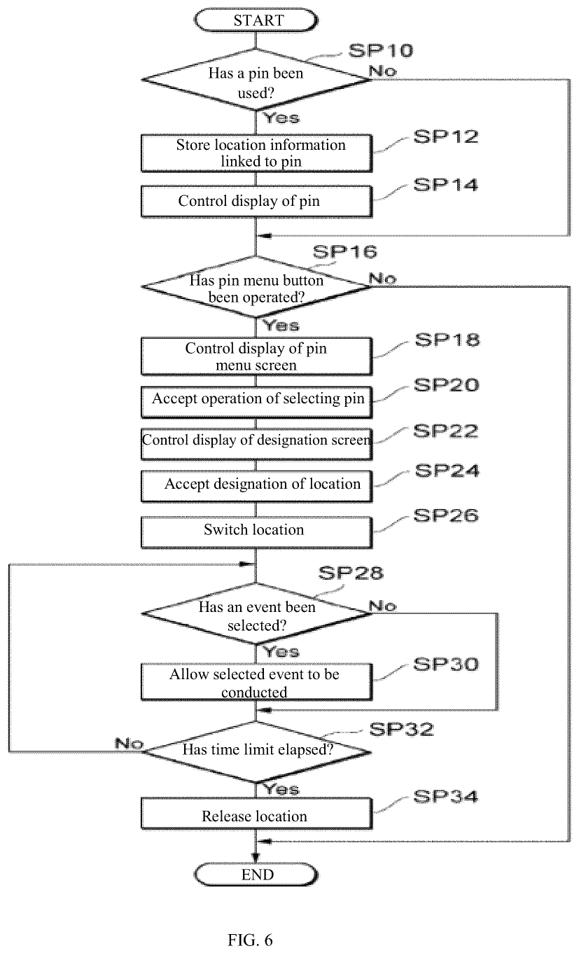

FIG. 6 is a flowchart showing an example of the flow of processing executed by the terminal device 12 in the game system 1 according to one or more embodiments. The processing in the following steps is executed repeatedly at time intervals, such as every 0.1 second, for example. Also, the order and content of the following steps can be changed as needed.

### Step SP10

The switching unit 60 determines whether or not a pin (second object) is being used from among the items possessed by the player P. If the determination is positive, the processing moves to the processing of step SP12, and if the determination is negative, the processing moves to the processing of step SP16.

### Step SP12

The memory control unit 58 stores the location information of the first object O1 in the server device 10 to be associated with the pin used in step SP10. Then, the processing moves to the processing of step SP14.

### Step SP14

The display control unit 50 controls the display of the pin in the game field 72 at the location indicated by the location information that is linked to that pin.

FIG. 7B is a diagram showing a game screen 70B continuing from the game screen 70A shown in FIG. 7A. FIG. 7C is a diagram showing a game screen 70C continuing from the game screen 70B shown in FIG. 7B.

As shown in FIG. 7B, in the game field 72, a pin O2 is displayed (placed) at the location indicated by the location information linked to the pin O2, that is, at the location indicated by the location information of the first object O1. After this, as shown in FIG. 7C, the first object O1 moves away from the location indicated by the location information linked to the pin O2 and the virtual landmark M as the player P moves.

Going back to FIG. 6, the processing moves to the processing of step SP16.

### Step SP16

The display control unit 50 determines whether or not a pin menu button (not shown) of the menu buttons 76 has been pressed. If the determination is positive, the processing moves to the processing of step SP18, and if the determination is negative, the series of processing shown in FIG. 6 comes to an end.

### Step SP18

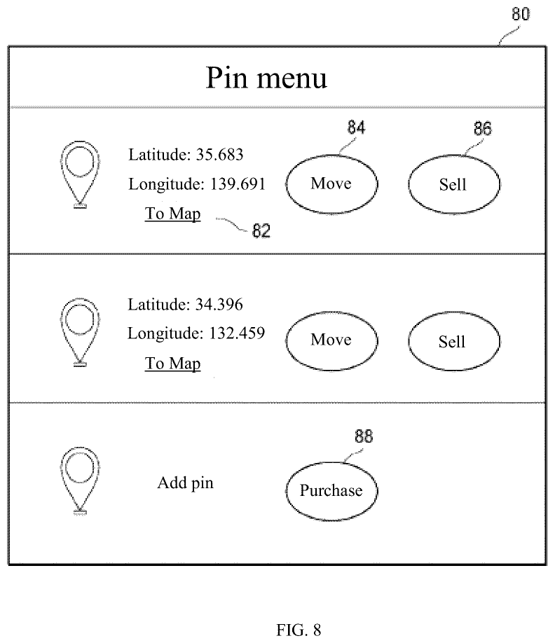

The display control unit 50 controls the display of the pin menu screen on the display 32A. FIG. 8 is a diagram showing an example of a pin menu screen 80.

As shown in FIG. 8, the pin menu screen 80 includes a map button 82, a move button 84, a sell button 86, and a purchase button 88. The map button 82 is used to view details of the location indicated by the location information linked to the pin O2 on the map (game field 72). The move button 84 is used to move the location of the first object O1 to a location based on the location information linked to the pin O2. More specifically, the move button 84 is used to switch the location of the first object O1 from a location corresponding to the location information acquired by the acquisition unit 54 to a location based on the location information linked to the pin O2. The sell button 86 is used to sell the pin O2 linked to the location information to another player or to the game system. Examples of the compensation obtained through a sale include unpaid currency, items, weapons, and armor. The purchase button 88 is used to purchase the pin O2 by consuming unpaid currency.

Going back to FIG. 6, the processing moves to the processing of step SP20.

### Step SP20

The display control unit 50 accepts the selection operation of the pin O2. More specifically, the display control unit 50 accepts a pressing operation of one of the move buttons 84 displayed on the pin menu screen 80. Then, the processing moves to the processing of step SP22.

### Step SP22

The display control unit 50 controls the display of a location designation screen on the display 32A.

FIG. 7D is a diagram showing an example of a designation screen 70D for accepting a location designation from the player P.

As shown in FIG. 7D, the designation screen 70D includes a game field 72, a range R centered on the location indicated by the location information stored by the memory control unit 58 in the game field 72, that is, the location information linked to the pin O2, and a location designation object O3 that can be moved by the player P and is used to designate a location.

Going back to FIG. 6, the processing moves to the processing of step SP24.

### Step SP24

In response to an operation by the player P, the switching unit 60 accepts the designation of one location within the range R, including the location indicated by the location information linked to the pin O2, as a location based on this location information.

More specifically, as shown in FIG. 7D, the switching unit 60 accepts the designation of one location by moving the location designation object O3 in response to an operation by the player P within the range R centered on the location indicated by the location information linked to the pin O2.

Going back to FIG. 6, the processing moves to the processing of step SP26.

### Step SP26

The switching unit 60 switches the location of the first object O1 from a location corresponding to the location information acquired by the acquisition unit 54 to a location based on the location information linked to the pin O2, that is, a location where the designation was accepted through an operation by the player P. This switching is accompanied by deletion of the selected pin O2 by the switching unit 60.

FIG. 7E is a diagram showing a game screen 70E continuing from the game screen 70C shown in FIG. 7C.

As shown in FIGS. 7C and 7E, the location of the first object O1 is switched from the location corresponding to the location information acquired by the acquisition unit 54 to the location where the designation was accepted through the operation by the player P. Also, the pin O2 is deleted in FIG. 7E.

Going back to FIG. 6, the processing moves to the processing of step SP28.

### Step SP28

The progression unit 52 determines whether or not the player P has selected one of the game events, such as a game event at the virtual landmark M located around the location of the first object O1, a game event at the spot S, or a game event with an enemy character E. If the determination is positive, the processing moves to the processing of step SP30, and if the determination is negative, the processing moves to the processing of step SP32.

### Step SP30

The progression unit 52 allows the selected game event to proceed. After the game event is over, the processing moves to the processing of step SP32.

### Step SP32

The release unit 62 determines whether or not the condition has been satisfied that a time limit has elapsed since the location of the first object O1 was switched to a location based on the location information linked to the pin O2. If the determination is positive, the processing moves to the processing of step SP34, and if the determination is negative, the processing returns to the processing of step SP28.

### Step SP34

The release unit 62 releases the location of the first object O1 from the location based on the location information linked to the pin O2, and returns it to a location corresponding to the location information acquired by the acquisition unit 54.

### Effect

As discussed above, in one or more embodiments, the terminal device 12, which allows a game event to be conducted while a first object O1 is moved in a virtual world W2, is made to function as an acquisition unit 54 for acquiring location information of a player P in the real world W1, a movement control unit 56 for moving the first object O1 to a location in the virtual world W2 corresponding to location information acquired by the acquisition unit 54, a memory control unit 58 for storing the location information of the player P or the location information of the first object O1 in response to an operation by the player P, a switching unit 60 for switching, in response to an operation by the player P, the location of the first object O1 from a location corresponding to the location information acquired by the acquisition unit 54 to a location based on the location information stored by the memory control unit 58, and a release unit 62 for releasing the location of the first object O1 from the location based on the location information stored by the memory control unit 58 and for returning it to the location corresponding to the location information acquired by the acquisition unit 54 when a specific condition is satisfied.

With this configuration, the location of the first object O1 can be switched to a location near a game event (such as a game event at the virtual landmark M), allowing the player P to participate in the game event without having to stay at a location near the game event. Another possible method involves participating in a game event from a long distance without switching the location of the first object O1, however switching the location of the first object O1 to a location near the game event of the virtual landmark M also allows the player to participate in other game events in the surrounding area (a game event at the spot S or a game event with an enemy character E). Also, when a specific condition has been satisfied, the location of the first object O1 is returned to its original location (the location corresponding to the location information acquired by the acquisition unit 54), which prevents the gameplay of a location-based game from being disrupted while providing the entertainment factor of allowing the player P to move around.

Also, in one or more embodiments, in response to an operation by the player P, the switching unit 60 accepts the designation of one location within the specific range R including the location indicated by the location information stored in the memory control unit 58 as a location based on this location information.

With this configuration, the location of the first object O1 can be switched to a location desired by the player P, such as a location where the player P can participate in more game events, or a location where the player P can participate in a desired game event.

Also, in one or more embodiments, in response to an operation by the player P, the memory control unit 58 stores location information of the player P or location information of the first object O1 to be associated with the pin O2 (serving as a second object different from the first object O1), and causes the terminal device 12 to further function as the display control unit 50 for controlling the display of the pin O2 in the virtual world W2 at the location indicated by the location information linked to the pin O2.

With this configuration, the location indicated by the location information stored in the memory control unit 58 can be visually confirmed from the pin O2, so the player P is less likely to forget having put the pin O2 at that location.

Also, in one or more embodiments, in response to an operation by the player P, the switching unit 60 switches the location of the first object O1 from a location corresponding to the location information acquired by the acquisition unit 54 to a location based on the location information linked to the pin O2, allowing the pin O2 to be transferred between players P.

With this configuration, a pin O2 linked to location information can be bought and sold between players P, allowing players P to move the first object O1 to a location in the virtual world W2 corresponding to a place they have never been to, and to participate in a game event there.

In one or more embodiments, the terminal device 12 is made to function as a granting unit 64 for granting a reward based on the location of the pin O2.

With this configuration, the player P can be encouraged to use the pin O2.

Also, in one or more embodiments, the memory control unit 58 stores the location information of the player P or the location information of the first object O1 in response to an operation by the player P of using a specific item, and an upper limit is set for the number of use of the specific item.

This configuration prevents the gameplay of a location-based game from being disrupted while providing the entertainment factor of allowing the player P to move around. Also, if an upper limit is set for the number of use of a specific item, a strategy will be required for where to use the limited number of specific items, and this makes the game more entertaining.

Also, in one or more embodiments, the terminal device 12 is made to function as the suggestion unit 66 for suggesting to the player P the use of a specific item based on an item or character possessed by the player P and a location corresponding to the location information acquired by the acquisition unit 54.

This configuration encourages the use of a specific item, that is, the placement of the pin O2.

Also, in one or more embodiments, the release unit 62 changes the specific condition for returning the location of the first object O1 based on the amount of movement of the player P.

This configuration encourages the player P to move for the purpose of changing the specific condition.

### Modifications

The present invention is not limited to or by the above embodiments. That is, suitable design changes made to the above embodiments by a person skilled in the art are also encompassed by the scope of the present invention as long as they still have the features of the present invention. Also, the elements of the embodiments above and the modified examples (discussed below) can be combined to the extent that this is technically possible, and these combinations are also encompassed by the scope of the present invention as long as they still have the features of the present invention.

For example, in the above embodiments, an example was described in which the granting unit 64 granted a reward based on the location of the second object, but the reward may instead be granted based on the number of use of a specific item.

Also, in the above embodiments, an example was described in which the switching unit 60 switched the location of the first object O1 in response to an operation by the player P, but the player P may be required to consume parameters such as stamina or game currency as compensation for doing this. That is, in response to an operation by the player P, the switching unit 60 may switch the location of the first object O1 when the player P consumes parameters.

Also, an example was described in which the memory control unit 58 stored location information of the player P or location information of the first object O1 in response to an operation by the player P of using a specific item, but a second object to which location information has already been linked may also be consumed during that time. The consumed second object may be a second object that is linked to location information of the location closest to the location indicated by the location information of the first object O1.

Also, the second object linked to the location information may be color-coded between the player P and other players. Also, the second object linked to the location information of the player P may be displayed so as to be visible to other players.

Also, the second object may have different values depending on the type. For instance, a second object (specific item) that is not linked to location information may be set to a value of 100 unpaid stones, and a second object that is linked to location information may be set to a value of 500 unpaid stones. Also, a second object linked to location information of a rural location may be set to a higher or lower value than a second object linked to location information of an urban location. Also, the value may be set higher in proportion to the distance between the location of the first object O1 of the player P who purchases the second object and the location indicated by the location information to which the second object is linked. Also, the value may vary with the distance between the home location, such as the home or office, of the player P who purchases the second object and the location indicated by the location information to which the second object is linked. For example, the value may be set higher in proportion to the distance between the home location, such as the home or office, of the player P who purchases the second object and the location indicated by the location information to which the second object is linked.

Also, the consumption amount when using a specific item may be set to be higher or lower in a predetermined location. Examples of this predetermined location include urban locations, rural locations, popular locations, unpopular locations, etc.

Also, the progression unit 52 or the granting unit 64 may prioritize a player P who participates in an event by switching the location of the first object O1 over a player P who participates in the event at a location corresponding to the location information of player P, or vice versa. For example, the granting unit 64 may lower the value of the reward or reduce the amount of the reward that can be acquired in an event to a player P who participates in the event by switching the location of the first object O1, as compared to a player P who participates in the event at a location corresponding to the location information of player P. Also, the progression unit 52 may lower the status of the player P (hit points, attack power, defense power, etc.), or increase the status of an enemy character E, so as to make an event more difficult to clear for a player P who participates in the event by switching the location of the first object O1 than for a player P who participates in the event at a location corresponding to the location information of the player P.

Also, the switching unit 60 may prohibit switching of the location of the first object O1 when the distance between the location indicated by the location information of the player P and the location based on the location information linked to the second object is at or above a threshold value. This encourages the player P to move so that the distance between the location indicated by the location information of the player P and the location based on the location information linked to the second object is below a threshold value.

Conversely, the switching unit 60 may prohibit the switching of the location of the first object O1 if the distance between the location indicated by the location information of the player P and the location based on the location information linked to the second object is below a threshold value. This encourages the player P to move so that the distance between the location indicated by location information of the player P and the location based on the location information linked to the second object is at or above a threshold value.

Also, in the above embodiments, an example was described in which the switching unit 60 switched the location of the first object O1 to a location based on the location information stored by the memory control unit 58, but the location may instead be switched to a location in the virtual world W2 corresponding to a place to which the player P cannot move, such as a restricted area, the sea, an iceberg, a cliff, or a lake. In this case, instead of storing location information of the player P or location information of the first object O1, the memory control unit 58 stores location information of a location in the virtual world W2 corresponding to a location to which player P cannot move in response to an operation by the player P.

Also, in the above embodiments, an example was described in which the location information was associated with the second object, but time information may be linked to the second object instead of location information. Using a second object linked to time information permits reproduction of the in-game environment (the occurrence status of an event, the appearance status of a monster, etc.) at the time indicated by the time information linked to the second object. For example, if location information is linked to a second object at 6:00 p.m. on April 1st, the in-game environment at 6:00 p.m. on April 1st will be reproduced when that second object is used at a subsequent date.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

10 . . . server device (computer, information processing device), 12 . . . terminal device (computer, information processing device), 50 . . . display control unit, 54 . . . acquisition unit, 56 . . . movement control unit, 58 . . . memory control unit, 60 . . . switching unit, 62 . . . release unit, 64 . . . granting unit, 66 . . . suggestion unit

What is claimed is:

1. A non-transitory computer readable recording medium storing instructions that cause a computer to conduct a game event, the instructions causing the computer to execute:
acquiring first location information of a player in a real world;
moving a first object in a virtual world to a location corresponding to the first location information;
storing, in a memory, second location information of the player or of the first object in response to an operation on a display by the player;
in response to an operation on the display by the player, switching a location of the first object from the location corresponding to the first location information to a location based on the second location information;
after the switching of the location of the first object, receiving an operation on the display by the player to select a game event from among one or more game events occurring around the location of the first object that has been switched, and conducting the game event selected by the operation; and
upon detecting that a specific condition has been satisfied, releasing the location of the first object from the location of the first object that has been switched and returning the location of the first object to the location corresponding to the first location information.

2. The non-transitory computer readable recording medium according to claim 1, wherein
the switching includes:
in response to the operation, accepting a designation of one location within a specific range including a location indicated by the second location information, as the location based on the second location information.

3. The non-transitory computer readable recording medium according to claim 1, wherein
the storing includes:
in response to the operation, storing the second location information to be associated with a second object different from the first object, and
the instructions further cause the computer to execute:
displaying, in the virtual world, the second object at a location indicated by the second location information associated with the second object.

4. The non-transitory computer readable recording medium according to claim 3, wherein
the switching includes:
in response to the operation, switching the location of the first object from the location corresponding to the first location information to the location based on the second location information associated with the second object, and
the second object is transferable between a plurality of players.

5. The non-transitory computer readable recording medium according to claim 3,
the instructions further cause the computer to execute:
granting a reward based on a location of the second object.

6. The non-transitory computer readable recording medium according to claim 3, wherein
the storing includes:
storing the second location information in response to an operation to use a specific item by the player, and
the specific item has an upper limit on a number of use.

7. The non-transitory computer readable recording medium according to claim 6, wherein
the instructions further cause the computer to execute:
suggesting via the display using the specific item based on an item or character possessed by the player and the location corresponding to the first location information.

8. The non-transitory computer readable recording medium according to claim 1, wherein
the releasing includes:
changing the specific condition based on a movement amount of the player.

9. An information processing device that conduct a game event, the information processing device comprising:
a memory;
a display;
a central processing unit (CPU) that:
acquires first location information of a player in a real world;
moves an object in a virtual world to a location corresponding to the first location information;
stores, in the memory, second location information of the player or of the object in response to an operation on a display by the player;
in response to an operation on the display by the player, switches a location of the object from the location corresponding to the first location information to a location based on the second location information;
after the switching of the location of the object, receives an operation on the display by the player to select a game event from among one or more game events occurring around the location of the object that has been switched, and conducts the game event selected by the operation; and
upon detecting that a specific condition has been satisfied, releases the location of the object from the location of the object that has been switched and returning the location of the object to the location corresponding to the first location information.
